(19) United States
(12) Patent Application Publication
(10) Pub. No.: US 2026/0049523 A1
(43) Pub. Date: Feb. 19, 2026

(54) DECORATIVE WINDOW BRACKETS FOR STORM PANELS

(71) Applicant: Nancy Myers, Stuart, FL (US)

(72) Inventor: Nancy Myers, Stuart, FL (US)

(21) Appl. No.: 19/291,169

(22) Filed: Aug. 5, 2025

Related U.S. Application Data
(60) Provisional application No. 63/679,850, filed on Aug. 6, 2024.
(60) Provisional application No. 63/689,357, filed on Aug. 30, 2024.

(51) Int. Cl. E06B 9/01; E06B 9/00

(52) U.S. Cl. CPC E06B 9/01; E06B 2009/005; E06B 2009/015

(57) ABSTRACT

A bracket assembly for use in securing a panel to protect a structure opening from high winds. The assembly employing a triangular shape retaining bracket hingedly attached a base member. The base member secured to a Structure with fasteners wherein the retaining bracket may be placed in an open position for receipt of a storm panel, and then placed in a closed position to secure the panel in position. The retainer bracket and base member have reciprocal tab members that will receive a pin member to secure the bracket in a closed position. The retaining bracket is preferably of a decorative design wherein the retaining bracket becomes a permanent decorative accessory to the structure, the retaining bracket conceals the base member when in the closed position.

### PRIORITY CLAIM

In accordance with 37 C.F. R. 1.76, a claim of priority is included in an Application Data Sheet filed concurrently herewith. Accordingly, the present invention claims priority of U.S. Provisional Patent Application No. 63/679,850 entitled “DECORATIVE WINDOW BRACKETS FOR STORM PANELS”, filed Aug. 6, 2024 and U.S. Provisional Ser. No. 63/689,357 entitled “DECORATIVE WINDOW BRACKETS FOR STORM PANELS”, filed Aug. 30, 2024; the content of the above referenced application is incorporated herein by reference in its entirety.

### FIELD OF THE INVENTION

The invention is directed to window protection and, in particular, to a window bracket that allows for ease of storm panel placement.

### BACKGROUND OF THE INVENTION

Covering windows during a storm is important for several reasons. High winds can break windows and turn loose objects into dangerous projectiles that can break windows at any speed. It is well recognized that covering windows with storm shutters, plywood, or impact-resistant glass can prevent these objects from breaking the glass and causing injuries or additional damage inside the home.

Covering windows also prevents water and wind from entering a structure. Broken windows allow rain and wind to enter the house, which can cause significant water damage to floors, walls, and personal belongings.

A protected window maintains integrity of the structure. If windows break during a storm, it can lead to increased air pressure inside the house. This pressure differential can potentially lift the roof off or cause other structural failures. Properly covering windows helps maintain the house's structural integrity by keeping the pressure more consistent.

Most standard residential windows are not designed to withstand extremely high wind speeds. They can typically withstand wind speeds up to 100 mph (category 1 hurricanes), depending on the quality and installation. However, this does not take into account debris that may impact the window wherein debris and a light wind can substantially damage a windowpane.

Protective films can increase a window's resistance to shattering but do not significantly increase the wind speed a window can withstand. Films require a semi-permanent attached to the glass and do not protect the perimeter of the windowpane wherein caulk is used to fill gaps between the window frame and the structure opening. Further, protective films can obscure the clarity of the window especially if the film begins to yellow or peel.

Impact-resistant windows are designed to withstand higher wind speeds and impacts from debris. They can generally withstand wind speeds up to 150-200 mph, which is the equivalent of a category 4 or 5 hurricane. However, such windows must be properly installed and are prone to leaking when the sealing caulk around the window frame has dried up.

Plywood shutters provide an additional layer of protection, allowing windows to withstand higher wind pressures and impacts from debris. Plywood is conventionally secured to wood frame homes using nails, and to cinder block homes using masonry screws such as Tapcon screws, Unfortunately, the use of nails and screws damaged frame or cinder blocks for the temporality attachment.

Known devices for use in securing panels to a structure include: U.S. Publication No. 20040250475 discloses channels adapted to cover the four edges of a rectangular panel of material such as siding, sheet rock or the like, Fingers extending from the ends of the facie portions to engage a panel, while bolts spaced along the channels draw the facie together against the panel.

U.S. Pat. No. 9,217,276 discloses a triangular flange bracket for attaching transparent rigid plastic panels over door and window openings with brackets which are attached to both the panels and both sides of the openings.

U.S. Publication No. 20130239497 discloses a system for protecting openings on building structures. The securing devices are semi-permanently attached at the corners adjacent a building opening, and releasably receive the corners of the protective panel. The bracket supports the bottom edge of the protective panel. In one embodiment the securing devices and bottom support structure are unitarily formed with a window.

U.S. Publication No. 20120073201 discloses mounting structures for building openings. The system of brackets may be removably mounted onto a door, window, or other building opening and to which may be attached a protective panel which substantially covers the window or other building structure. Such a system may be used, for example, to provide protection to doors, windows and other building openings against flying debris from hurricanes and to other severe storms.

U.S. Pat. No. 7,861,472 discloses a mounting apparatus providing for securement of a protective panels such as, for example, plywood and the like, to exterior surfaces of buildings to protect windows, doors and/or other vulnerable features from wind and flying debris. The device comprises a stationary base, and a clamping member attached to such base. At least one device of the present invention is mounted to a building in general proximity to a window, door or other feature to be covered with a protective panel; the clamping member(s) secure the protective panels in place against the building, When not in use, the present invention can be maintained in a stowed position.

U.S. Pat. No. 6,393,777 discloses a window guard assembly having permanent window brackets installed on the exterior sides of a window framing of a building or residential home at the top and bottom thereof. A top set of window brackets is arranged with mechanical fasteners as first and second inverted J-shaped mounting brackets. A bottom set of window brackets is disposed on the bottom window framing as first and second mounting brackets, and the bottom brackets are aligned with the top set of window brackets.

U.S. Pat. No. 7,654,044 discloses a window or door with a radially extending metal or vinyl casing flange mounted in an opening of a building having vinyl siding is protected from hurricanes and other violent weather by providing a panel having dimensions greater than the opening and bracket receiving slots; and a plurality of L-shaped brackets having base plates and perpendicular mounting plates. The bracket base plates are inserted between the window flange and the vinyl siding and secured to the building with fasteners, which are inserted into a wooden frame surrounding the building opening, The panel is then positioned over the opening, with the mounting plates inserted through the slots. The panel is secured in place by temporary fasteners, such as cotter keys.

U.S. Pat. No. 9,228,391 discloses a device and a method to protect building openings with plywood panels during storm. The device and method is also provided to protect inside of buildings when windows or doors are broken. The bracket allows attachment of plywood panels without shaping to cover windows and other building openings of any shape,

U.S. Pat. No. 9,587,427 discloses a restraint system for temporarily restraining a generally rectangular panel in an opening of an outdoor structure having a pair of longitudinally extending side portions, a base portion connected to each of the pair of longitudinally extending side portions at respective proximal ends of each of the pair of longitudinally extending generally parallel, inwardly inclined side portions, protruding members arranged along a bottom surface of the base portion for frictionally engaging a side portion of an opening of an outdoor structure during an operational use of the restraint system, and a tab portion configured to allow a user to grab and pull the restraint system out of the opening. The pair of longitudinally extending side portions and the base portion form a generally u-shaped configuration with a gap therebetween adapted for receiving a side portion of a generally rectangular panel.

What is lacking in the art is a decorative window bracket that is permanently attached to a structure and readily allows for ease of storm panel placement.

### SUMMARY OF THE INVENTION

Disclosed is an assembly that provides ease of storm panel attachment. The assembly consists of a rigid panel that is temporarily held in place using retainer brackets. The retainer brackets are triangular shaped and adapted to receive a corner of a rigid storm panel, such as a piece of plywood, used to provide a barrier against debris breaching the opening of a structure during a wind event. Each retainer bracket includes a hinge member attached to a building structure using base member. The brackets are hingedly secured to the corners of the building opening wherein a securement pin allows the retainer bracket to be rotated into an open position for receipt of a panel, and the securement pin locks the panel in position when the securement pin is placed within reciprocal aperture formed on the retainer bracket and the base member.

An objective of the invention is to provide a low cost storm securement assembly that allows for ease in securing a rigid panel to a structure to protect from wind damage.

Another objective of the invention is to provide a decorative assembly that can be left on the building structure year round.

Other objectives and advantages of this invention will become apparent from the following description taken in conjunction with any accompanying drawings wherein are set forth, by way of illustration and example, certain embodiments of this invention.

### BRIEF DESCRIPTION OF THE DRAWINGS

FIG. 1 is a plane view of a first window bracket illustrated in a locked position and a second window bracket in an unlocked position;

FIG. 2 is an environmental view of a structure with window brackets;

FIG. 3 is a plane view of window brackets securing a panel in position;

FIG. 4 is a plane view of the back side of a window bracket ;

FIG. 5 is an environmental view of an alternative window bracket illustrated as window shutters in a locked position;

FIG. 6 is a plane view of the alternative window bracket illustrated in an unlocked position;

FIG. 7 is plane view of the alternative window bracket securing a panel in position;

FIG. 8 is a plane view of the back side of the alternative window bracket;

FIG. 9 is an environmental view of a decorative door bracket and track;

FIG. 10 is a plane view of the decorative door bracket in an unlocked position;

FIG. 11 is a plane view of the decorative door bracket and track securing a panel in position; and

FIG. 12 is a plane view of the back side of the decorative door bracket ;

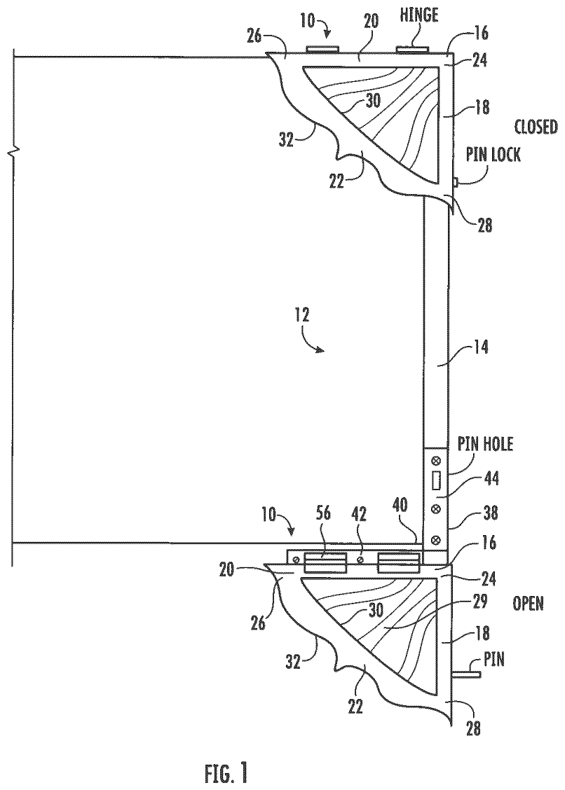

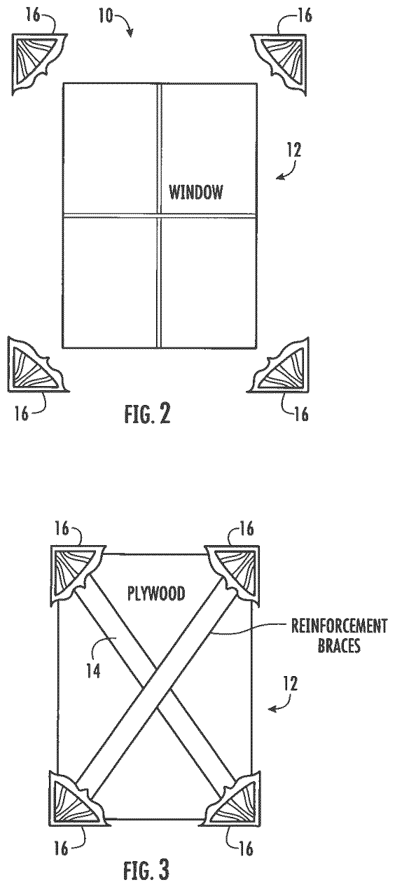

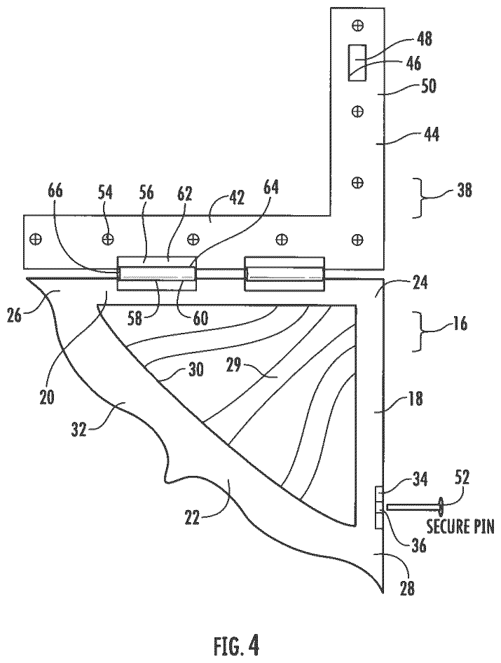

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Disclosed is a bracket assembly 10 for use in securing a panel to protect a structure opening 12 from high winds. The bracket assembly 10 includes a rigid panel 14 sized to cover the structure opening 12. The rigid panel 14 refers to any barrier against debris breaching the structure opening 12, such as plywood or reinforced braces. The structure opening 12 refers to any designated space within a building's framework intended for the installation of windows or doors.

The bracket assembly 10 further includes a retaining bracket 16 having a first sidewall 18, a second sidewall 20, and a third side wall 22 with a first vertex 24 that connects the first sidewall 18 and the second sidewall 20, a second vertex 26 connecting the second sidewall 20 and the third sidewall 22, and a third vertex 28 connecting the third sidewall 22 and said first sidewall 18. The retaining bracket 16 may further include reinforcement connector walls 29 between said first 18 and second sidewall 20 and third sidewall 22. In preferred embodiment, the bracket assembly 10 includes a reinforcement connector wall 29 between the first vertex 24 and the third sidewall 22. The reinforcement connector walls 29 are typically designed for aesthetic purposes and are not limiting to the size, shape, and number of walls.

The connection of all the sidewalls 18, 20, 22 form a triangular shape that includes an inner surface 30 and an outer surface 32 shaped and adapted to receive a corner of a rigid storm panel 14, such as a piece of plywood, used to provide a barrier against debris breaching the structure opening 12 during a wind event. Additionally, on the first sidewall 18 is a first raised tab 34 with an aperture 36 placed therethrough.

The bracket assembly 10 further includes a base member 38 formed from a rigid plate 40 that corners the structure opening 12. The base member 38 includes a first leg 42 placed at a right angle to a second leg 44. The first leg 42 has a hinge 56 secured to the second sidewall 20 of the retaining bracket 16. The hinge 56 has a first leaf 58 secured to the second sidewall 20 with at least one first knuckle 60. A second leaf 62 is secured to the base member 38 with at least one second knuckle 64. A pin 66 extends through each knuckle 60, 64 pivotally connecting the first leaf 58 to the second leaf 62.

The second leg 44 includes a second raised tab 46 with an aperture 48 placed therethrough. The second raised tab 48 extends outwardly from a surface 50 of the second leg 44. The second raised tab 46 corresponds with the first raised tab 34. Once a rigid storm panel 14, such as plywood, is inserted into the corner of the structure opening 12, the retaining bracket 16 can be lifted to the base member 38 wherein the second raised tab 48 on the second leg 44 is constructed and arranged to cooperate with the first raised tab 34 on the first sidewall 18. A pin member 52 constructed for placement within the first raised tab aperture 36 and the second raised tab aperture 48 then secures the retaining bracket 16 to the base member 38. When the retaining bracket 16 is placed in an open position upon the removal of the pin member 52, a rigid panel 14 to cover the structure opening 12 is allowed to be placed, whereby the retaining bracket 16 is secured to the base member 38 by the pin member 52 for securing the rigid panel 14 to the structure.

Moreover, the base member 38 itself includes a plurality of apertures 54 for receipt of fasteners for securing the base member 38 to the structure opening 12.

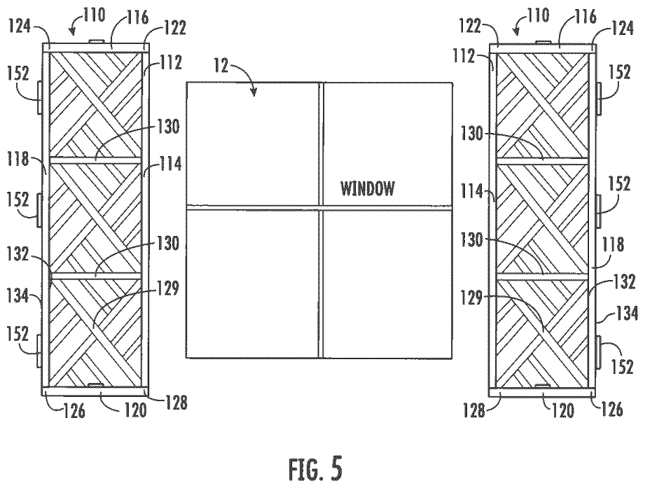

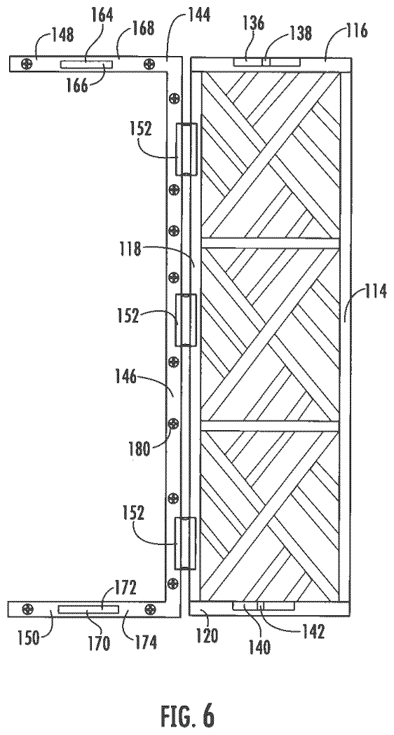

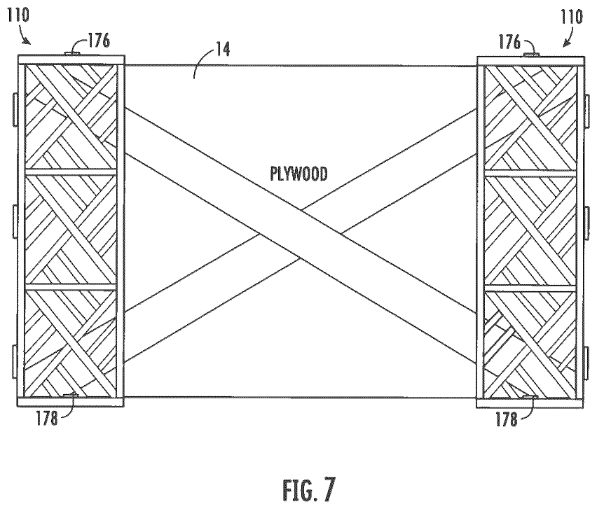

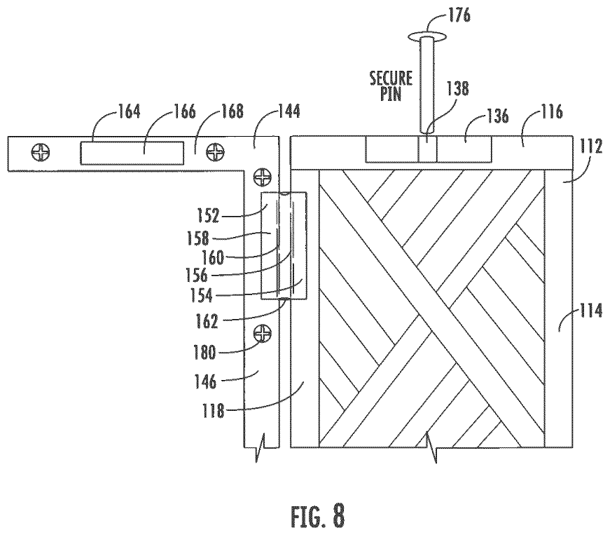

FIGS. 5-8 represent an alternative embodiment of the present invention. Disclosed is another embodiment of the bracket assembly 110 for use in securing a panel to protect a structure opening 12 from high winds. In this embodiment, the bracket assembly 110 represents window shutters and a bracket assembly 110 is placed in both sides of a structure opening 12, such as a window. The bracket assembly 110 includes a retaining bracket 112 having a first sidewall 114, a second sidewall 116, a third sidewall 118, and a fourth sidewall 120. In a preferred embodiment, the first 114, second 116, third 118, and fourth sidewalls 120 form a rectangular shape wherein the first sidewall 114 and the third sidewall 118 are parallel to each other and the second sidewall 116 and the fourth sidewall 120 are parallel to each other.

The retaining bracket 112 further includes a first vertex 122 that connects the first sidewall 114 and the second sidewall 116, a second vertex 124 that connects the second sidewall 116 and the third sidewall 118, a third vertex 126 that connects the third sidewall 118 and the fourth sidewall 120, and a fourth vertex 128 that connects the fourth sidewall 120 and the first sidewall 114. The retaining bracket 112 may further include a plurality of cross bracings 130 that connect the first sidewall 114 to the third sidewall 118. In preferred embodiment, the retaining bracket 112 includes reinforcement connector walls 129 between any combination of the first 114, second 116, third 118, and fourth sidewalls 120 and the cross bracings 130. The reinforcement connector walls 129 are typically designed for aesthetic purposes and are not limiting to the size, shape, and number of walls.

The connection of all the sidewalls 114, 116, 118, 120 form a rectangular shape that includes an inner surface 132 and an outer surface 134 shaped and adapted to receive a corner of a rigid storm panel 14, such as a piece of plywood, used to provide a barrier against debris breaching the structure opening 12 during a wind event. Additionally, on the second sidewall 116 is a first raised tab 136 with an aperture 138 placed therethrough and on the fourth sidewall 120 is a second raised tab 140 with an aperture 142 placed therethrough.

The bracket assembly 110 further includes a base member 144 formed from a rigid plate 146 sized and shaped as the third sidewall 118. The base member 144 includes a first leg 148 extending outwardly in a perpendicular direction to the rigid plate 146 and located at the top of the base member 144. A second leg 150 extends outwardly in a perpendicular direction to the rigid plate and is located at the bottom of the base member 144. In a preferred embodiment, the length of both the first leg 148 and the second leg 150 is equivalent to the length of the second sidewall 116 and the fourth sidewall 120, respectively. The first leg 148 and the second leg 150 are placed at a right angle to the rigid plate 146.

The rigid plate 146 has a plurality of hinges 152 secured to the third sidewall 118 of the retaining bracket 112. The hinge 152 has a first leaf 154 secured to the third sidewall 118 with at least one first knuckle 156. A second leaf 158 is secured to the rigid plate 146 with at least one second knuckle 160. A pin 162 extends through each knuckle 156, 160 pivotally connecting the first leaf 154 to the second leaf 158.

The first leg 148 includes a third raised tab 164 with an aperture 166 placed therethrough. The third raised tab 164 extends outwardly from a surface 168 of the first leg 148. The third raised tab 164 corresponds with the first raised tab 136 on the second sidewall 116. Similarly, the second leg 150 includes a fourth raised tab 170 with an aperture 172 placed therethrough. The fourth raised tab 170 extends outwardly from a surface 174 of the second leg 150. The fourth raised tab 170 corresponds with the second raised tab 140 on the fourth sidewall 120. Once a storm panel 14, such as plywood, is inserted into the corner of the base member 144 between the rigid plate 146 and the second leg 150, the retaining bracket 112 can be lifted to the base member 144 wherein the third raised tab 164 on the first leg 148 and the fourth raised tab 170 on the second leg 150 is constructed and arranged to cooperate with the first raised tab 136 on the second sidewall 116 and the second raised tab 140 on the fourth sidewall 120, respectively. A first pin member 176 constructed for placement within the first raised tab aperture 138 and the third raised tab aperture 166 and a second pin member 178 constructed for placement within the second tab aperture 142 and the fourth raised tab aperture 172 then secures the retaining bracket 112 to the base member 144. When the retaining bracket 112 is placed in an open position upon the removal of the pin members 176, 178, a rigid panel 14 to cover the structure opening 12 is allowed to be placed, whereby the retaining bracket 112 is secured to the base member 144 by the pin members 176, 178 for securing the rigid panel 14 to the surrounding area of the structure opening.

Moreover, the base member 144 itself includes a plurality of apertures 180 for receipt of fasteners for securing the base member 144 to the structure surrounding area of the structure opening 12.

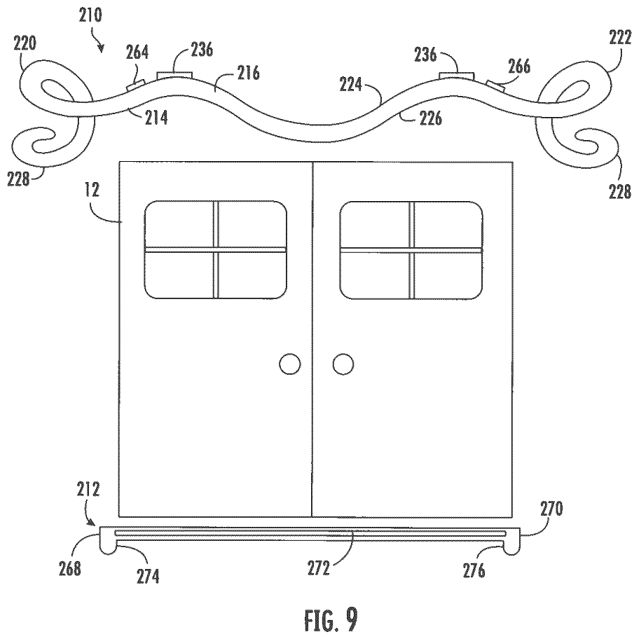

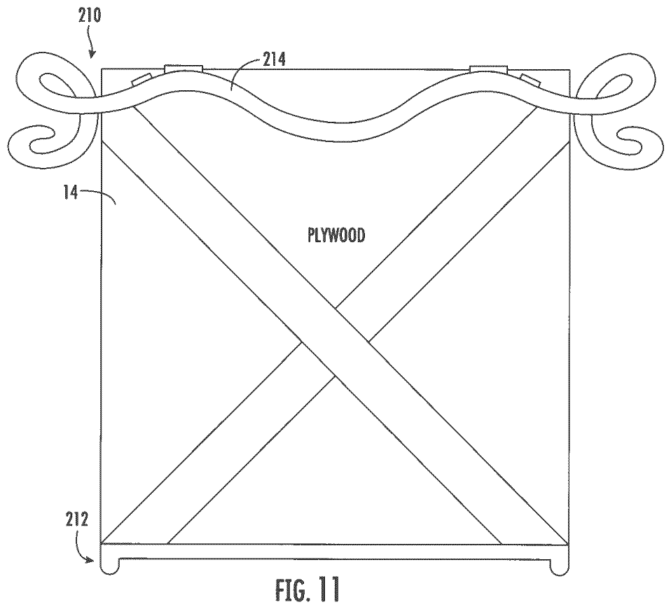

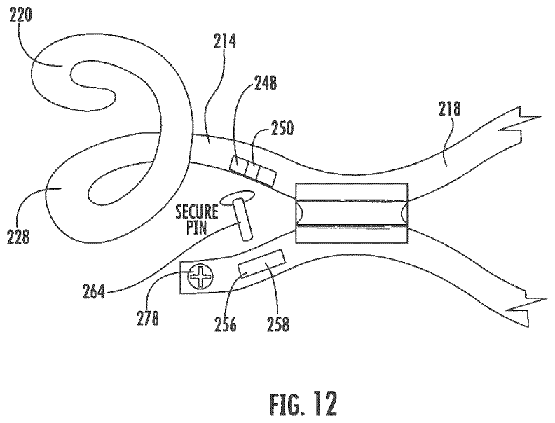

FIGS. 9-12 represent the present invention as a decorative door mantle for use in securing a panel to protect a structure opening 12 from high winds. Disclosed is a bracket assembly 210 and a track 212 used to protect the structure opening 12, such as a door or window, from flying debris from hurricanes and other severe storms by securing a rigid storm panel 14, such as plywood, to provide a barrier against flying debris. The panel 14 slides into a track 212 seated in front of a structure opening 12, such as a door, and is then seated behind the bracket assembly 210 in a locked position in order to prevent the debris from damaging the door.

The bracket assembly 210 includes a retaining bracket 214 having an outer surface 216 and an inner surface 218. The retaining bracket 214 has a length spanning from a proximal end 220 to a distal end 222. In a preferred embodiment, the length of the retaining bracket 214 is greater than a length of the structure opening 12 so that the decorative mantle retains an aesthetic appearance above the structure opening 12, such as a door. The retaining bracket 214 also includes a top surface 224 and a bottom surface 226. The general shape and size of the retaining bracket 214, and in turn the bracket assembly 210, is not limiting, as many different embodiments may exist for the aesthetic design of the bracket assembly 210. For example, in the disclosed embodiment, the top surface 224 and the bottom surface 226 of the retaining bracket 214 remain equidistant while the bracket assembly 210 forms a curved, ribbon-like pattern. Towards the ends of the retaining bracket 214 are decorative ends 228 that are mirrored and visually appealing. The bracket assembly 210 may further include connector walls or cross bracings to enhance the visual appeal, not shown. Additionally, on the inner surface 218 of the retaining bracket 214 is a first raised tab 248 with an aperture 250 placed therethrough located near the proximal end 220 and a second raised tab 252 with an aperture 254 placed therethrough located near the distal end 222.

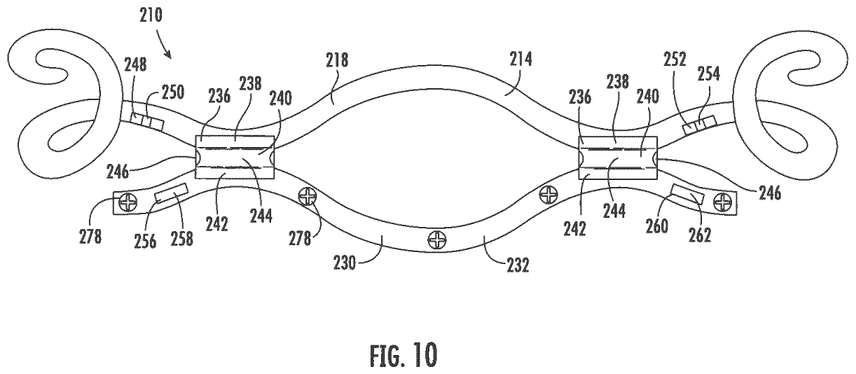

Now referring to FIG. 10, the bracket assembly 210 includes a base member 230 formed from a rigid plate 232 that is mounted above the structure opening 12. The base member 230 includes an inner surface having a plurality of hinges 236 secured to the inner surface 218 of the retaining bracket 214. The hinge 236 has a first leaf 238 secured to the inner surface 218 of the retaining bracket 214 with at least one first knuckle 240. A second leaf 242 is secured to the base member 230 with at least one second knuckle 244. A pin 246 extends through each knuckle 240, 244 pivotally connecting the first leaf 238 to the second leaf 242.

The base member 230 includes a third raised tab 256 with an aperture 258 placed therethrough and a fourth raised tab 260 with an aperture 262 placed therethrough. The third raised tab 256 and the fourth raised tab 260 extend outwardly from the inner surface 234 of the base member 230. The third raised tab 256 corresponds with the first raised tab 248 and the fourth raised tab 260 corresponds with the second raised tab 252.

The track 212 has a length between a proximal end 268 and a distal end 270 and is located directly in front of the structure opening 12, such as a door. The track 212 is constructed and arranged to receive a rigid storm panel 14 within a trough 272 that prevents the panel 14 from moving in the forwards and backwards direction. The track 212 further includes a first stop 274 located at the proximal end 268 and a second stop 276 located at the distal end 270 that prevents the panel 14 from moving in the lateral directions. The position of the first stop 274 and the second stop 276 can be adjusted along the length of the trough 272 in order to compensate for different sized panels 14. Once the first stop 274 and the second stop 276 are in place, the panel 14 is secured to the ground within the track 212.

Once a rigid storm panel 14, such as plywood, is inserted and secured into the track 212, the retaining bracket 214 can be lifted to the base member 230 wherein the third raised tab 256 is constructed and arranged to cooperate with the first raised tab 248 and the fourth raised tab 260 is constructed and arranged to cooperate with the second raised tab 252, respectively. A first pin member 264 constructed for placement within the first raised tab aperture 250 and the third raised tab aperture 258 and a second pin member 266 constructed for placement within the second raised tab aperture 254 and the fourth raised tab aperture 262 then secures the retaining bracket 214 to the base member 230. When the retaining bracket 214 is placed in an open position upon the removal of the first pin member 264 and the second pin member 266, a rigid panel 14 to cover the structure opening 12 is allowed to be placed, whereby the retaining bracket 214 is secured to the base member 230 by the first pin member 264 and the second pin member 266 for securing the rigid panel 14 to the structure opening 12.

Moreover, the base member 230 itself includes plurality of apertures 278 for receipt of fasteners for securing the base member 230 above the structure opening 12.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” “contains” one or more steps or elements, possesses those one or more steps or elements, but is not limited to possessing only those one or more elements. Likewise, a step of a method or an element of device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A bracket assembly for use in securing panel to protect a structure opening from high winds comprising:
a rigid panel sized to cover said structure opening; such as a window or door;
a retaining bracket having a first sidewall, a second sidewall, and a third sidewall with a first vertex connecting said first sidewall and said second sidewall, a second vertex connecting said second sidewall and said third sidewall, and a third vertex connecting said third sidewall and said first sidewall, said sidewalls forming triangular shape with an inner surface and an outer surface, said first sidewall including first raised tab with an aperture placed therethrough;
a base member formed from a rigid plate having a first leg placed right angle to a second leg, said first leg having a hinge secured to said second sidewall of said retaining bracket, said second leg including a second raised tab with an aperture placed therethrough, said second raised tab extending outwardly from surface of said second leg constructed and arranged to cooperate with said first raised tab, said base member including a plurality of apertures for receipt of fasteners for securing said base member to said structure opening, and
a pin member constructed for placement within said first and second raised tab aperture;
wherein said retaining bracket is placed in an open position upon removal of said pin member allowing placement of said rigid panel to cover said structure opening, whereby said retaining bracket is secured to said base member by said pin member for securing said rigid panel to said structure opening.

2. The bracket assembly according to claim 1 wherein said structure opening is a door or window.

3. The bracket assembly according to claim 1 wherein said hinge has first leaf secured to said second sidewall with at least one first knuckle, and a second leaf secured to said base member with at least one second knuckle, and a pin extending through each said knuckle pivotally connecting said first leaf to said second leaf.

4. The bracket assembly according to claim 1 including reinforcement connector walls between said first and second sidewall and third sidewall.

5. The bracket assembly according to claim 1 including a reinforcement connector wall between said first vertex and said third sidewall.

6. A bracket assembly for use in securing panel to protect a structure opening from high winds comprising:
a rigid panel sized to cover said structure opening; such as a window or door;
a retaining bracket having a first sidewall, a second sidewall, a third sidewall, and a fourth sidewall with a first vertex connecting said first sidewall and said second sidewall, a second vertex connecting said second sidewall and said third sidewall, a third vertex connecting said third sidewall and said fourth sidewall, vertex connecting said fourth sidewall to said first sidewall, said sidewalls forming a rectangular shape with an inner surface and an outer surface, said first sidewall including a first raised tab with an aperture placed therethrough and said fourth sidewall including a second raised tab with an aperture placed therethrough,
a base member formed from a rigid plate having a first leg extending outwardly in a perpendicular direction to said rigid plate and located at the top of said base member and a second leg extending outwardly in a perpendicular direction to said rigid plate located at the bottom of said base member, said rigid plate having a plurality of hinges secured to said third sidewall of said retaining bracket, said first leg including a third raised tab with an aperture placed therethrough, said second leg including a fourth raised tab with an aperture placed therethrough, said third raised tab extending outwardly from a surface of said first leg constructed and arranged to cooperate with said first raised tab, said fourth raised tab extending outwardly from surface of said second leg constructed and arranged to cooperate with said second raised tab, said base member including a plurality of apertures for receipt of fasteners for securing said base member to a surrounding area of said structure opening;
first pin member constructed for placement within said first raised tab aperture and said third raised tab aperture; and
a second pin member constructed for placement within said second raised tab aperture and said fourth raised tab aperture;
wherein said retaining bracket is placed in an open position upon removal of said first pin member and said second pin member allowing placement of said rigid panel to cover said structure opening, whereby said retaining bracket is secured to said base member by said first pin member and said second pin member for securing said rigid panel to said surrounding area of said structure opening.

7. The bracket assembly according to claim 6 wherein said structure opening is a door or window.

8. The bracket assembly according to claim 6 wherein each said hinge has a first leaf secured to said third sidewall with at least one first knuckle, and a second leaf secured to said rigid plate with at least one second knuckle, and a pin extending through each said knuckle pivotally connecting said first leaf to said second leaf.

9. The bracket assembly according to claim 6 wherein a plurality of cross bracings connect said first sidewall to said third sidewall.

10. The bracket assembly according to claim 9 including reinforcement connector walls between any combination of said first, second, third, or fourth sidewalls and said cross bracings.

11. A bracket assembly for use in securing a panel to protect a structure opening from high winds comprising:
a rigid panel sized to cover said structure opening; such as a window or door;
a retaining bracket having an outer surface, an inner surface, a top surface, and a bottom surface, said retaining bracket having a length extending from a proximal end to a distal end, said inner surface including a first raised tab with an aperture placed therethrough located near said proximal end id a second raised tab with an aperture therethrough located near said distal end;
a track located in front of said structure opening having a length between a proximal end and a distal end, said track including a trough constructed and arranged to receive said rigid panel preventing movement of said rigid panel in the forwards and backward direction, said track including a first stop located at said proximal end and a second stop located at said distal end preventing movement of said rigid panel in lateral directions;
a base member formed from a rigid plate having an inner surface having a plurality of hinges secured to said inner surface of said retaining bracket, said base member including a third raised tab with an aperture placed therethrough and a fourth raised tab with aperture placed therethrough, said third raised tab extending outwardly from said inner surface of said base member constructed and arranged to cooperate with said first raised tab, said fourth raised tab extending outwardly from said inner surface of said base member constructed and arranged to cooperate with said second raised tab, said base member including a plurality of apertures for receipt of fasteners for securing said base member to a surrounding area of said structure opening;
a first pin member constructed for placement within said first raised tab aperture and said third raised tab aperture; and
a second pin member constructed for placement within said second raised tab aperture and said fourth raised tab aperture;
wherein said retaining bracket is placed in an open position upon removal of said first pin member and said second pin member allowing placement of said rigid panel to cover said structure opening, whereby said retaining bracket is secured to said base member by said first pin member and said second pin member for securing said rigid panel to said structure opening.

12. The bracket assembly according to claim 11 wherein said length of said retaining bracket is greater than a length of said structure opening.

13. The bracket assembly according to claim 11 wherein said top surface and said bottom surface are equidistant along said length of said retaining bracket.

14. The bracket assembly according to claim 11 wherein said first stop and said second stop are adjustable along a length of said trough.

15. The bracket assembly according to claim 11 wherein said structure opening is a door or window.

16. The bracket assembly according to claim 11 wherein each said hinge has a first leaf secured to said inner surface of said retaining bracket with at least one first knuckle, and a second leaf secured to said base member with at least one second knuckle, and a pin extending through each said knuckle pivotally connecting said first leaf to said second leaf.
